(19) United States
(12) Patent Application Publication
(10) Pub. No.: US 2020/0217504 A1
(43) Pub. Date: Jul. 9, 2020

(54) METHOD OF OPERATING AN OVEN APPLIANCE BASED ON FUEL TYPE

(71) Applicant: Haier US Appliance Solutions, Inc., Wilmington, DE (US)

(72) Inventor: Amelia Lear Hensley, Louisville, KY (US)

(21) Appl. No.: 16/240,867

(22) Filed: Jan. 7, 2019

(51) Int. Cl. F23N 5/18; F23N 1/00; F24C 3/12; F16K 11/10

(52) U.S. Cl. CPC F23N 5/184; F23N 1/002; F24C 3/126; F23N 2025/06; F16K 11/105; F23N 2005/185; F23N 2041/08; F24C 3/124

(57) ABSTRACT

An oven appliance and a method of operating the same are provided. The oven appliance includes a heating element, such as a cooktop gas burner and/or a gas heating element within a cooking chamber, which generate heat by burning a flow of fuel. A fuel regulating device, such as a bimetal or solenoid valve, is operably coupled to the heating element to selectively provide the flow of fuel to the heating element. A controller is configured for obtaining a fuel type of the flow of fuel and adjusting the operation of the fuel regulating device based at least in part on the fuel type of the flow of fuel.

### FIELD OF THE INVENTION

The present subject matter relates generally to oven appliances, and more particularly, to methods of operating gas oven appliances to compensate for input fuel types.

### BACKGROUND OF THE INVENTION

Conventional residential and commercial oven appliances generally include a cabinet that includes a cooking chamber for receipt of food items for cooking. Multiple gas heating elements are positioned within the cooking chamber to provide heat to food items located therein. The gas heating elements can include, for example, a bake heating assembly positioned at a bottom of the cooking chamber and/or a separate broiler heating assembly positioned at a top of the cooking chamber. In addition, oven appliances often include one or more gas burners, e.g., positioned at a cooktop surface for use in heating or cooking an object, such as a cooking utensil and its contents. These gas heating elements and gas burners typically combust a mixture of gaseous fuel and air to generate heat for cooking.

Conventional ovens or cooktops which include gas heating elements are usually designed to be installed with one of multiple allowed fuel systems. For example, gas ovens or cooktops can be installed with either natural gas or liquefied petroleum (LP) fuel systems. The output of a gas burner is determined by safety and regulatory requirements for each fuel. Typically, the operation of the range is optimized for the most common fuel system's burner output. This yields sub-optimum operation for ovens and cooktops installed with alternative fuel systems. Usually cooking appliances are set to work with natural gas from the factory, and a conversion is performed on the unit's regulator and on each burner to set it for use with LP fuel. When this conversion occurs, the burner output may be different, and will perform slightly differently if the operation of the burner is not altered. Presently known cooktop and oven appliances do not include suitable features for compensating for the use of different fuels while maintaining desired heat output.

Accordingly, an oven appliance and methods for operating the same based in part on the input fuel would be useful. More particularly, a method of operating gas heating elements or gas burners of an oven appliance to provide consistent heat output regardless of the input fuel would be particularly beneficial.

### BRIEF DESCRIPTION OF THE INVENTION

Aspects and advantages of the invention will be set forth in part in the following description, or may be apparent from the description, or may be learned through practice of the invention.

In a first example embodiment, an oven appliance defining a vertical, a lateral, and a transverse direction is provided. The oven appliance includes a cabinet, a cooking chamber positioned within the cabinet, and a heating element for generating thermal energy by burning a flow of fuel. A fuel regulating device is operably coupled to the heating element to selectively provide the flow of fuel to the heating element and a controller is operably coupled to the fuel regulating device. The controller is configured for obtaining a fuel type of the flow of fuel and adjusting the operation of the fuel regulating device based at least in part on the fuel type of the flow of fuel.

In a second example embodiment, a method of operating a flow regulating device to control a flow of fuel to a heating element of an oven appliance is provided. The method includes obtaining a fuel type of the flow of fuel and adjusting the operation of the fuel regulating device based at least in part on the fuel type of the flow of fuel.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a front, perspective view of an oven appliance according to an exemplary embodiment of the present subject matter.

FIG. 2 is a close-up cross sectional view of the exemplary oven appliance of FIG. 1, taken along Line 2-2 in FIG. 1.

FIG. 3 is a method of operating an oven appliance according to an exemplary embodiment of the present subject matter.

FIG. 4 is plot illustrating the power output of a gas heating element of the exemplary oven appliance of FIG. 1 when supplied with two different fuel types.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

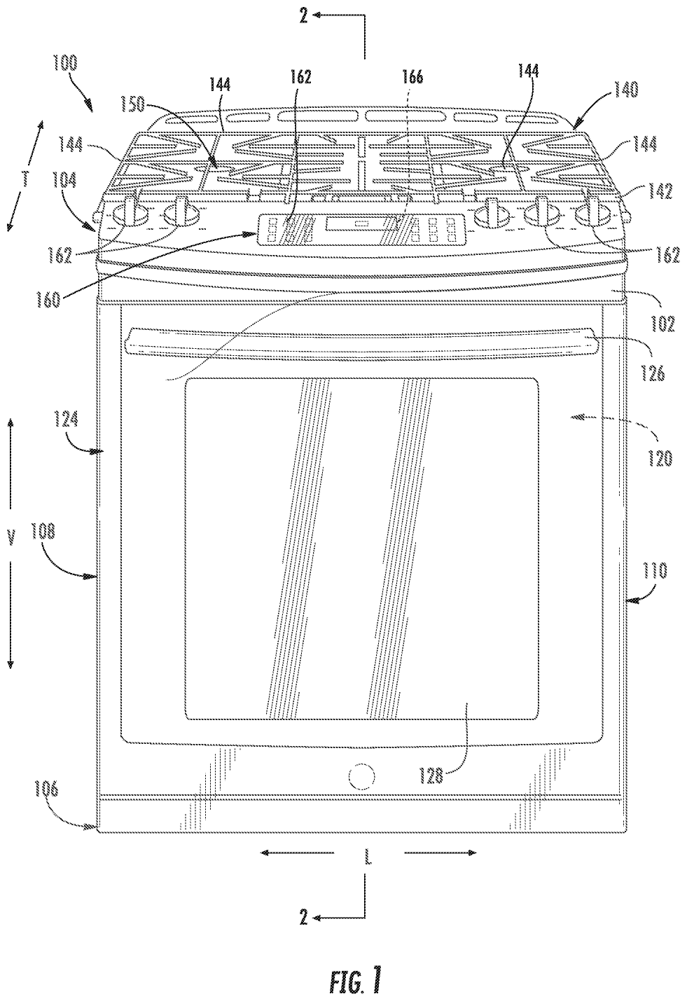

FIG. 1 provides a front, perspective view of an oven appliance 100 as may be employed with the present subject matter. Oven appliance 100 generally defines a vertical direction V, a lateral direction L, and a transverse direction T, each of which is mutually perpendicular, such that an orthogonal coordinate system is generally defined. As illustrated, oven appliance 100 includes an insulated cabinet 102. Cabinet 102 of oven appliance 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

Within cabinet 102 is a single cooking chamber 120 which is configured for the receipt of one or more food items to be cooked. However, it should be appreciated that oven appliance 100 is provided by way of example only, and aspects of the present subject matter may be used in any suitable cooking appliance, such as a double oven range appliance. Thus, the example embodiment shown in FIG. 1 is not intended to limit the present subject matter to any particular cooking chamber configuration or arrangement.

Oven appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120.

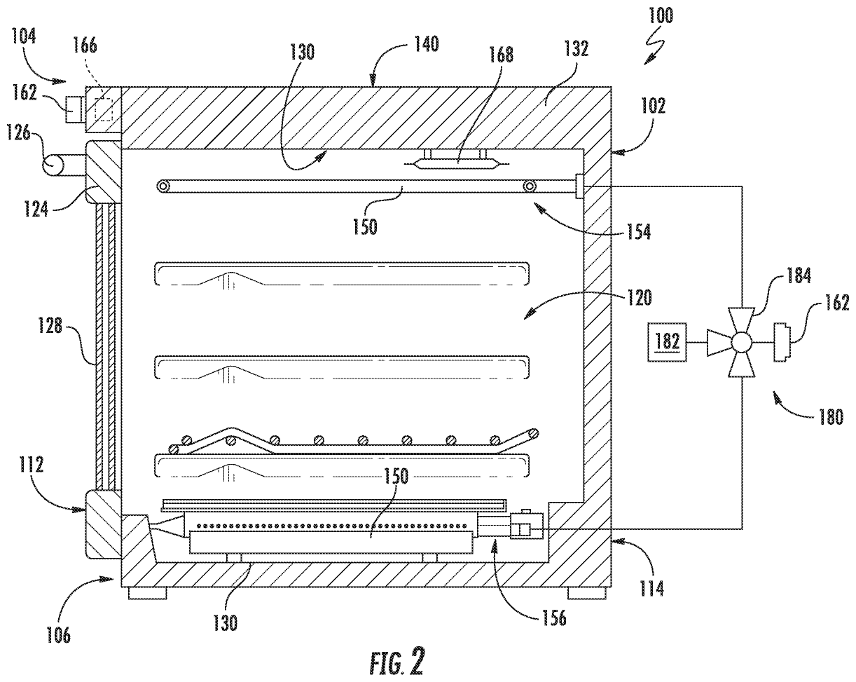

In general, cooking chamber 120 is defined by a plurality of chamber walls 130 (FIG. 2). Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, oven appliance 100 includes an insulating gap defined between the chamber walls 130 and cabinet 102. According to an exemplary embodiment, the insulation gap is filled with an insulating material 132, such as insulating foam or fiberglass, for insulating cooking chamber 120.

Oven appliance 100 also includes a cooktop 140. Cooktop 140 is positioned at or adjacent top 104 of cabinet 102 such that it is positioned above cooking chamber 120. Specifically, cooktop 140 includes a top panel 142 positioned proximate top 104 of cabinet 102. By way of example, top panel 142 may be constructed of glass, ceramics, enameled steel, and combinations thereof. One or more grates 144 are supported on a top surface of top panel 142 for supporting cooking utensils, such as pots or pans, during a cooking process.

Oven appliance may further include one or more heating elements (identified generally by reference numeral 150) for selectively heating cooking utensils positioned on grates 144 or food items positioned within cooking chamber 120. For example, referring to FIG. 1, heating elements 150 may be gas burners 152. Specifically, a plurality of gas burners 152 are mounted within or on top of top panel 142 such that grates 144 support cooking utensils over gas burners 152 while gas burners 152 provide thermal energy to cooking utensils positioned thereon, e.g., to heat food and/or cooking liquids (e.g., oil, water, etc.). Gas burners 152 can be configured in various sizes so as to provide e.g., for the receipt of cooking utensils (i.e., pots, pans, etc.) of various sizes and configurations and to provide different heat inputs for such cooking utensils. According to alternative embodiments, oven appliance 100 may have other cooktop configurations or burner elements.

In addition, heating elements 150 may be positioned within or may otherwise be in thermal communication with cooking chamber 120 for regulating the temperature within cooking chamber 120. Specifically, an upper gas heating element 154 may be positioned in cabinet 102, e.g., at a top portion of cooking chamber 120, and a lower gas heating element 156 may be positioned at a bottom portion of cooking chamber 120. Upper gas heating element 154 and lower gas heating element 156 may be used independently or simultaneously to heat cooking chamber 120, perform a broil operation, perform a cleaning cycle, etc. The size and heat output of gas heating elements 154, 156 can be selected based on the, e.g., the size of oven appliance 100 or the desired heat output. Oven appliance 100 may include any other suitable number, type, and configuration of heating elements 150 within cabinet 102 and/or on cooktop 140. For example, oven appliance 100 may further include electric heating elements, induction heating elements, or any other suitable heat generating device.

A user interface panel 160 is located within convenient reach of a user of the oven appliance 100. For this example embodiment, user interface panel 160 includes knobs 162 that are each associated with one of heating elements 150. In this manner, knobs 162 allow the user to activate each heating element 150 and determine the amount of heat input provided by each heating element 150 to a cooking food items within cooking chamber 120 or on cooktop 140. Although shown with knobs 162, it should be understood that knobs 162 and the configuration of oven appliance 100 shown in FIG. 1 is provided by way of example only. More specifically, user interface panel 160 may include various input components, such as one or more of a variety of touch-type controls, electrical, mechanical or electro-mechanical input devices including rotary dials, push buttons, and touch pads. User interface panel 160 may also be provided with one or more graphical display devices or display components 164, such as a digital or analog display device designed to provide operational feedback or other information to the user such as e.g., whether a particular heating element 150 is activated and/or the rate at which the heating element 150 is set.

Generally, oven appliance 100 may include a controller 166 in operative communication with user interface panel 160. User interface panel 160 of oven appliance 100 may be in communication with controller 166 via, for example, one or more signal lines or shared communication busses, and signals generated in controller 166 operate oven appliance 100 in response to user input via user input devices 136. Input/Output (“I/O”) signals may be routed between controller 166 and various operational components of oven appliance 100 such that operation of oven appliance 100 can be regulated by controller 166. In addition, controller 166 may also be communication with one or more sensors, such as temperature sensor 168 (FIG. 2), which may be used to measure temperature inside cooking chamber 120 and provide such measurements to the controller 166. Although temperature sensor 168 is illustrated at a top and rear of cooking chamber 120, it should be appreciated that other sensor types, positions, and configurations may be used according to alternative embodiments.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of oven appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Although aspects of the present subject matter are described herein in the context of a single oven appliance, it should be appreciated that oven appliance 100 is provided by way of example only. Other oven or range appliances having different configurations, different appearances, and/or different features may also be utilized with the present subject matter, e.g., double ovens, standalone cooktops, etc. Moreover, aspects of the present subject matter may be used in any other consumer or commercial appliance where it is desirable to operating a heating element capable of burning multiple different fuel types.

Referring now specifically to FIG. 2, a schematic view of upper gas heating element 154 and lower gas heating element 156 within a cooking chamber 120 and a fuel supply system 180 will be described. In general, fuel supply system 180 is configured for selectively supplying gaseous fuel such as propane, natural gas, liquefied petroleum (LP), butane, or any other suitable fuel to heating elements 150 to regulate the amount of heat generated. In particular, fuel supply system 180 includes pressurized gaseous fuel source 182, such as a natural gas supply line, a propane tank, etc. In this manner, a flow of supply fuel, such as gaseous fuel (e.g., natural gas or propane), is flowable from the pressurized gaseous fuel source 182 to heating elements 150.

Fuel supply system 180 further includes a control valve or fuel regulating device 184 operably coupling gaseous fuel source 182 to heating elements 150. Specifically, as illustrated, fuel regulating device 184 is a three-way, solenoid-controlled valve or bimetal valve for selectively directing a metered amount of fuel to upper gas heating element 154 and lower gas heating element 156. More specifically, according to an exemplary embodiment, control knob 162 (or user interface panel 160 more generally) may be operably coupled to flow regulating device 184 for regulating the flow of supply fuel. In this regard, a user may rotate control knob 162 to adjust the position of flow regulating device 184 and the flow of supply fuel from gaseous fuel source 182 to both upper gas heating element 154 and lower gas heating element 156.

Now that the construction and configuration of oven appliance 100 and fuel supply system 180 have been described according to exemplary embodiments of the present subject matter, an exemplary method 200 for operating oven appliance 100 will be described according to an exemplary embodiment of the present subject matter. Method 200 can be used to operate oven appliance 100 using fuel supply system 180, or may be used to operate any other suitable oven appliances. In this regard, for example, controller 166 may be configured for implementing some or all steps of method 200. Further, it should be appreciated that the exemplary method 200 is discussed herein only to describe exemplary aspects of the present subject matter, and is not intended to be limiting.

Referring now to FIG. 3, method 200 includes, at step 210, obtaining a fuel type of a flow of fuel being supplied to a gas heating element. For example, continuing the example from above, fuel supply system 180 may use fuel regulating device 184 to provide a flow of fuel from gaseous fuel source 182 two one or more of heating elements 150. Notably, as explained briefly above, the power output of a given heating element 150 depends on the fuel type burned by that heating element 150. Step 210 includes determining the fuel type by any suitable means so that the control algorithm may be adjusted to compensate for such power output and achieve the desired thermal energy from the heating element.

For example, the fuel type may be set by a user or manufacturer of the appliance. In this manner, determining the fuel type may include determining a position of a selector switch (e.g., one of control knobs 162) which is set by a user or automatically toggled when a fuel supply is connected. Alternatively, the fuel type may be input via user interface panel 160 which is operably coupled with controller 166. Thus, controller 166 may adjust the control algorithm for operating fuel supply system 180 to compensate for the differences in fuel type. According still other embodiments, the fuel type may be determined by measuring a pressure of the flow of fuel. In this regard, each particular fuel type may have a particular supply pressure for proper combustion or burning. By determining the supply pressure using a pressure sensor, the fuel type may be determined and appropriate compensations may be implemented.

Method 200 further includes, at step 220, adjusting the operation of a fuel regulating device based at least in part on the fuel type of the flow of fuel. For example, adjusting the operation of the fuel regulating device may include increasing a duty cycle if the fuel type as a lower average power than a programmed or nominal fuel (e.g., a manufacturer set fuel type) or decreasing the duty cycle of the fuel type has a higher average power than the programmed fuel. According still other embodiments adjusting the operation of fuel regulating device may include adjusting the flow rate of the flow of fuel based on the fuel type for adjusting the flow of fuel to achieve the desired energy output.

As mentioned above, fuel supply system 180 may regulate the total energy output of heating elements 150 by cycling the flow of fuel on and off or by regulating a flow rate through fuel regulating device 184. As used herein, the “duty cycle” of fuel supply system 180 is intended to refer generally to the ratio of the amount of time fuel regulating device 180 is supplying fuel to a heating element 150 to the amount of time fuel regulating device 184 is closed. Thus, the duty cycle of fuel supply system 180 may be roughly proportional to the total heat or energy output for a given heating element 150. In this regard, for example, a fifty percent duty cycle may correspond to heating element 150 operating at fifty percent of its rated power, an eighty percent duty cycle may correspond to heating element 150 operating at eighty percent of its rated power, etc. Thus, generally speaking, increasing the duty cycle results in heating element 150 operating longer and thus outputting more energy over a given time period, and vice versa. It should be appreciated that other means for controlling the power level of heating elements 150 and fuel supply system 180 are possible and within the scope of the present subject matter.

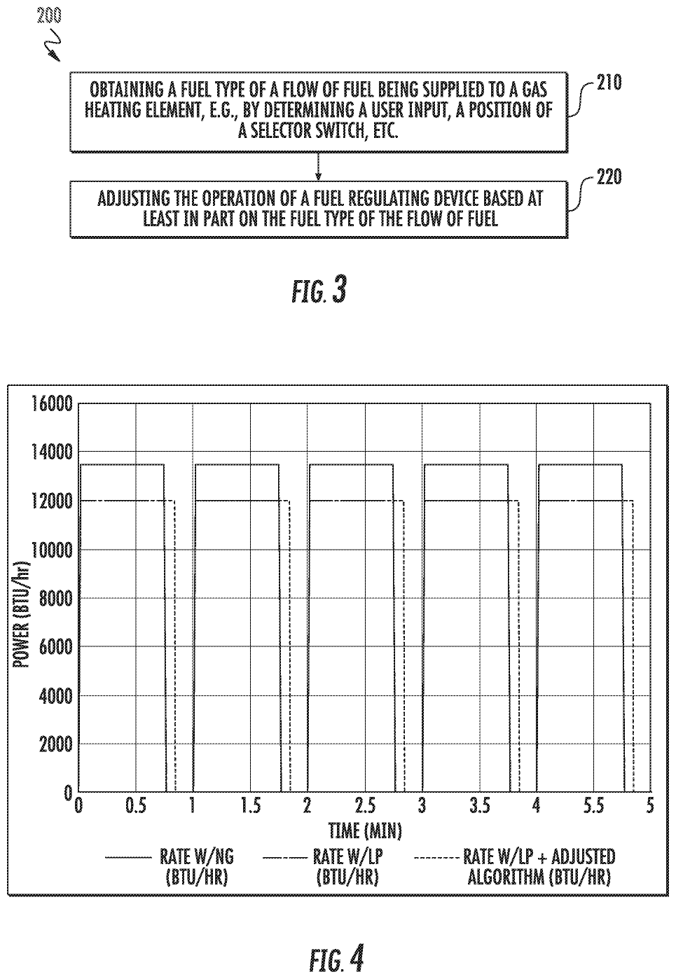

More particularly, for example, a conventional oven appliance may typically be optimized for operation with natural gas when delivered from a factory. Thus the control algorithms and editing controller 166 may be optimized for natural gas. For example, as shown in FIG. 4, when a heating element is supplied with natural gas, it may burn at a higher power level than if supplied with liquefied petroleum (LP). Specifically, for example, LP gas may burn at approximately 12,000 BTUs per hour, while natural gas may burn for approximately 13,500 BTUs per hour. It should be appreciated that as used herein, terms of approximation, such as “approximately,” “substantially,” or “about,” refer to being within a ten percent margin of error.

However, if a user converts the oven appliance for use with liquefied petroleum, the control algorithms may no longer be optimized. To rectify this, controller 166 may detect the fuel type (e.g., at step 210 described above) and may adjust the operation of fuel regulating device 184 (e.g. by modifying the control algorithm). Specifically, for example, controller 166 may adjust the duty cycle of flow regulating device such that the average operating time of heating element 150 when using liquefied petroleum is approximately 1.125 times longer than when natural gas is used, e.g., such that roughly the same amount of thermal energy may be supplied to cooking chamber 120.

FIG. 3 depicts an exemplary control method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of the methods are explained using oven appliance 100 and fuel supply system 180 as an example, it should be appreciated that these methods may be applied to monitoring the operation of any suitable oven appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An oven appliance defining a vertical, a lateral, and a transverse direction, the oven appliance comprising:
a cabinet;
a cooking chamber positioned within the cabinet;
a heating element for generating thermal energy by burning a flow of fuel;
a fuel regulating device operably coupled to the heating element to selectively providing the flow of fuel to the heating element; and
a controller operably coupled to the fuel regulating device, the controller being configured for:
obtaining a fuel type of the flow of fuel; and
adjusting the operation of the fuel regulating device based at least in part on the fuel type of the flow of fuel.

2. The oven appliance of claim 1, wherein the heating element is a gas heating element positioned within the cooking chamber.

3. The oven appliance of claim 1, wherein the heating element is a gas burner positioned on a cooktop of the oven appliance.

4. The oven appliance of claim 1, wherein the fuel regulating device comprises a bimetal or a solenoid control valve.

5. The oven appliance of claim 1, wherein obtaining the fuel type of the flow of fuel comprises:
determining a position of a selector switch that is set by a user.

6. The oven appliance of claim 1, wherein obtaining the fuel type of the flow of fuel comprises:
determining an input from a user interface panel of the oven appliance.

7. The oven appliance of claim 1, wherein obtaining the fuel type of the flow of fuel comprises:
determining a pressure of the flow of fuel.

8. The oven appliance of claim 1, wherein adjusting the operation of the fuel regulating device comprises:
increasing a duty cycle if the fuel type has a lower average power that a programmed fuel or decreasing the duty cycle if the fuel type has a higher average power than the programmed fuel.

9. The oven appliance of claim 1, wherein adjusting the operation of the fuel regulating device comprises:
adjusting a flow rate of the flow of fuel based on the fuel type.

10. The oven appliance of claim 1, wherein adjusting the operation of the fuel regulating device comprises:
adjusting the flow of fuel to achieve a desired energy output.

11. The oven appliance of claim 1, wherein the fuel type is either natural gas or liquefied petroleum.

12. The oven appliance of claim 11, wherein an average output of the heating element using liquefied petroleum is less than when natural gas is used.

13. A method of operating a flow regulating device to control a flow of fuel to a heating element of an oven appliance, the method comprising:
obtaining a fuel type of the flow of fuel; and
adjusting the operation of the fuel regulating device based at least in part on the fuel type of the flow of fuel.

14. The method of claim 13, wherein the heating element is a gas heating element positioned within the cooking chamber or a gas burner positioned on a cooktop of the oven appliance.

15. The method of claim 13, wherein obtaining the fuel type of the flow of fuel comprises:
determining a position of a selector switch that is set by a user.

16. The method of claim 13, wherein obtaining the fuel type of the flow of fuel comprises:
determining an input from a user interface panel of the oven appliance.

17. The method of claim 13, wherein adjusting the operation of the fuel regulating device comprises:
increasing a duty cycle if the fuel type has a lower average power that a programmed fuel or decreasing the duty cycle if the fuel type has a higher average power than the programmed fuel.

18. The method of claim 13, wherein adjusting the operation of the fuel regulating device comprises:
adjusting a flow rate of the flow of fuel based on the fuel type.

19. The method of claim 13, wherein adjusting the operation of the fuel regulating device comprises:
adjusting the flow of fuel to achieve a desired energy output.

20. The method of claim 13, wherein the fuel type is either natural gas or liquefied petroleum, wherein an average output of the heating element using liquefied petroleum is less than when natural gas is used.
